(19) United States
(12) Patent Application Publication
(10) Pub. No.: US 2012/0301163 A1
(43) Pub. Date: Nov. 29, 2012

(54) Image Forming Apparatus and Image Forming Method

(76) Inventors: Katsuyuki Hirata, Toyokawa-shi (JP); Hideaki Tanaka, Tokyo (JP); Toru Yamaguchi, Tokyo (JP); Takashi Harashima, Sagamihara-shi (JP); Takaaki Kooriya, Tokyo (JP)

(21) Appl. No.: 13/471,354

(22) Filed: May 14, 2012

(30) Foreign Application Priority Data
May 24, 2011 (JP) 2011-115802

(51) Int. Cl. G03G 15/00

(52) U.S. Cl. 399/49

(57) ABSTRACT

Provided are an image forming apparatus and an image forming method capable of easily forming an output image having desired gradation characteristics and capable of reducing running cost. In an intermediate transfer-type image forming apparatus, an image forming section is configured by including a first image forming section which forms a color toner image on a photoconductor, and a second image forming section which is located on the upstream side of the first image forming section and forms a transparent toner image on the photoconductor. Further, after the transparent toner image is formed on an intermediate transfer member by the second image forming section, the first image forming section forms, on the basis of image data (correction gradation values) corrected by a gradation correcting section, a color toner image so that the color toner image is superimposed on the transparent toner image.

### CROSS REFERENCE TO RELATED APPLICATIONS

This application is entitled to and claims the benefit of Japanese Patent Application No. 2011-115802, filed on May 24, 2011, the disclosure of which including the specification, drawings and abstract is incorporated herein by reference in its entirety.

### TECHNICAL FIELD

The present invention relates to an intermediate transfer-type age forming apparatus and an intermediate transfer-type image forming method.

### BACKGROUND ART

Conventionally, in color image forming apparatus (e.g., copiers, printers, facsimiles) using the electrophotographic process, an intermediate transfer system using an intermediate transfer member, such as an intermediate transfer belt, has been the mainstream. In the intermediate transfer system, toner images of C (cyan), M (magenta), Y (yellow) and K (black) colors, which are respectively formed on photoconductor drums, are transferred (primary-transferred) on an intermediate transfer member so as to be superimposed on one another, and then the four-color toner image formed on the intermediate transfer member is transferred (secondary-transferred) on a sheet.

A problem with such image forming apparatuses is that the image quality of an output image (image formed on the sheet) may be deteriorated due to, for example, time-dependent degradation of the photoconductor drums, developer and other components, and changes in the surrounding environment (variation in temperature and humidity). Specifically, a phenomenon occurs in which the gradation of the input image is not faithfully reproduced in the output image. To cope with this, the conventional image forming apparatus implements image stabilization control for stably reproducing, in the output image, the gradation, and the like, of the input image (see, for example, Patent Literature 1). Examples of the image stabilization control include the gradation correction control in which the density of each of CMYK color toner patterns formed on the intermediate transfer member is detected by a photosensor, and gradation correction data (so-called gamma correction curve) is generated on the basis of the detection result (gradation characteristics). The gradation correction data is fed back to the image forming conditions, such as charged potential, developing potential, and exposure light amount.

### CITATION LIST

### Patent Literature

PTL 1: Japanese Patent Application Laid-Open No. 2006-259261

### SUMMARY OF INVENTION

### Technical Problem

The image stabilization control (gradation correction) in the intermediate transfer-type image forming apparatus is achieved on the basis of the detection result of each of CMYK color toner patterns. With the gradation correction, therefore, the input image (monochromatic image) of each of the primary colors (primary colors of C, M, Y and K) is faithfully reproduced in the output image (the gradation reproducibility is guaranteed). As shown in FIG. 1, when a monochromatic image (monochromatic image of magenta (M) in FIG. 1) is formed, a part of the M toner is not transferred on a sheet at the time of the secondary transfer and is left as a residual toner on the intermediate transfer member. This means that the transfer ratio of M toner (the ratio of the amount of the toner transferred on the sheet) is not 100%. For this reason, the image stabilization control controls the image forming conditions in consideration of the residual toner which would be left at the time of the secondary transfer so that a toner can be transferred on the intermediate transfer member in an appropriate amount of toner necessary for reproducing an original image, that is, the amount of a toner that should be transferred on the sheet in order to reproduce an image with a desired density (gradation value). Even when the residual toner is generated at the time of the secondary transfer, an appropriate amount of toner is transferred on the sheet by performing the image stabilization control, and hence the gradation characteristics as designed are obtained in the output image.

On the other hand, an input image to be actually subjected to image formation is often a multicolor image (image formed by superposing a plurality of color toners) including a secondary color and a tertiary color, such as RGB and Pk (process black that is a mixture of colors). As shown in FIG. 2, when a multicolor image is formed (in FIG. 2, a multicolor image is formed by superposition of cyan (C) on magenta (M)), a part of the toner (M) of the lowermost layer in contact with the intermediate transfer member is left as a residual toner at the time of secondary transfer, while the toner (C) of the layer, which is not the lowermost layer nor is in contact with the intermediate transfer member, cannot be left as the residual toner. That is, at the time of secondary transfer, the transfer ratio of the toner (M) of the lowermost layer does not become 100%, while the transfer ratio of toner (C) of the layer that is not the lowermost layer reaches 100%.

However, in the above-described image stabilization control, the image forming conditions are set so that the reproducibility of the gradation of a monochromatic image is guaranteed, which means that the toner transfer ratio difference that occurs in the case of forming a multicolor image is not taken into consideration. The amount of the toner of the layer other than the lowermost layer, which amount larger than the appropriate amount of the toner, is transferred on the sheet (the density of the toner becomes high). As a result, a desired color tone cannot be obtained in the output image. Specifically, the maximum density and the halftone density are deviated from the design values, and hence the gradation characteristics as designed cannot be obtained.

In order to solve such a problem, it is conceivable that the reproducibility of a multicolor image is improved by setting, in the image stabilization control, the image forming conditions so that only the amount of the toner of the lowermost layer is increased by the amount of the residual toner. However, even when this technique is applied, the color toner of the lowermost layer still remains on the intermediate transfer member. The residual color toner is discarded without being used for image formation, and hence the technique needs to be further improved.

An object of the present invention is to provide an image forming apparatus and an image forming method which are capable of easily forming an output image having desired gradation characteristics and capable of reducing the running cost of the apparatus.

### Solution to Problem

To achieve at least one of the abovementioned objects, an image forming apparatus reflecting one aspect of the present invention is an intermediate transfer-type image forming apparatus including an image forming section including an exposure device for forming an electrostatic latent image on a photoconductor on the basis of input image data and a developing device for developing the electrostatic latent image by making a toner adhere to the photoconductor to form a toner image, an intermediate transfer section for transferring, on an intermediate transfer member, the toner image formed on the photoconductor and for transferring, on a sheet, the toner image transferred on the intermediate transfer member, and a gradation correcting section for performing gradation correction on the basis of gradation correction data, wherein the image forming section includes a first image forming section for forming a color toner image on the photoconductor. and a second image forming section for forming a transparent toner image on the photoconductor, the second image forming section located on the upstream side of the first image forming section, and wherein the second image forming section forms the transparent toner image on the intermediate transfer member, and then, on the basis of image data subjected to the gradation correction by the gradation correcting section, the first image forming section forms the color toner image by superimposing the color toner image on the transparent toner image.

To achieve at least one of the abovementioned objects, an image forming method reflecting one aspect of the present invention is an image forming method used in an intermediate transfer-type image forming apparatus for transferring, on an intermediate transfer member, a toner image formed on a photoconductor and for transferring, on a sheet, the toner image transferred on the intermediate transfer member, and the method including the steps of performing gradation correction on the basis of gradation correction data, forming a transparent toner image on the intermediate transfer member, and forming, on the basis of image data subjected to the gradation correction, a color toner image by superimposing the color toner image on the transparent toner image.

### Advantageous Effects of Invention

According to the present invention, a color toner image is formed on a transparent toner image formed on the intermediate transfer member, and hence the color toner is completely transferred on a sheet at the time of secondary transfer, so that the transparent toner is left on the intermediate transfer member. Therefore, it is not necessary to perform gradation correction in consideration of that the color toner is left on the intermediate transfer member at the time of secondary transfer, and hence an output image having desired gradation characteristics can be easily formed. Further, the color toner is not discarded as a residual toner, and hence the running cost can be reduced.

### BRIEF DESCRIPTION OF DRAWINGS

FIG. 1A is a schematic view showing a toner state (before secondary transfer) on an intermediate transfer member when a monochromatic image is formed;

FIG. 1B is a schematic view showing a toner state (after secondary transfer) on an intermediate transfer member when a monochromatic image is formed;

FIG. 2A is a schematic view showing a toner state (before secondary transfer) on the intermediate transfer member when a multicolor image is formed;

FIG. 2B is a schematic view showing a toner state (after secondary transfer) on the intermediate transfer member when a multicolor image is formed;

FIG. 3 schematically shows an entire configuration of an image forming apparatus according to an embodiment of the present invention;

FIG. 4 shows a main part of a control system of the image forming apparatus according to the embodiment;

FIG. 5 is a flow chart showing an example of gradation correction data generation processing;

FIG. 6 shows an example of a toner pattern used in the gradation correction data generation processing;

FIG. 7 shows a gradation correction curve adopted in the embodiment;

FIG. 8 shows a conventionally adopted gradation correction curve;

FIG. 9 is a flow chart showing an example of image forming processing in the image forming section;

FIG. 10A is a schematic view showing a toner state (before secondary transfer) on the intermediate transfer member when a multicolor image is formed by the image forming apparatus according to the embodiment; and

FIG. 10B is a schematic view showing a toner state (after secondary transfer) on the intermediate transfer member when a multicolor image is formed by the image forming apparatus according to the embodiment.

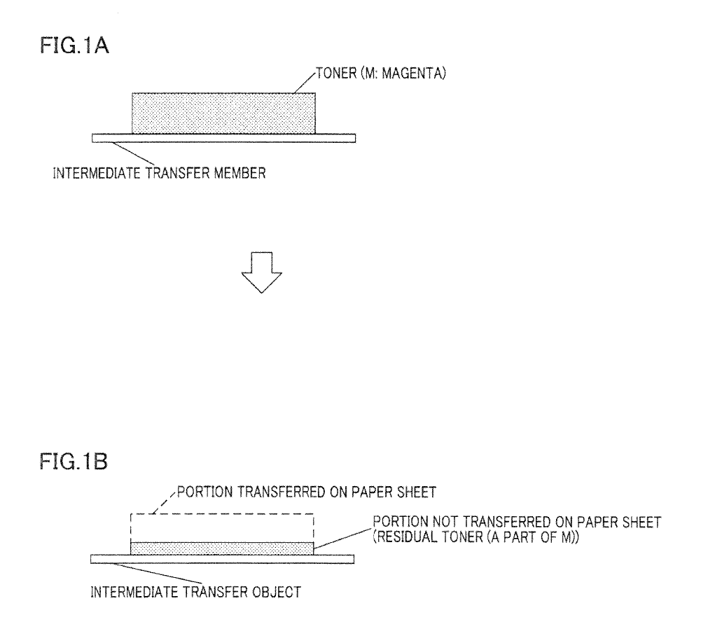

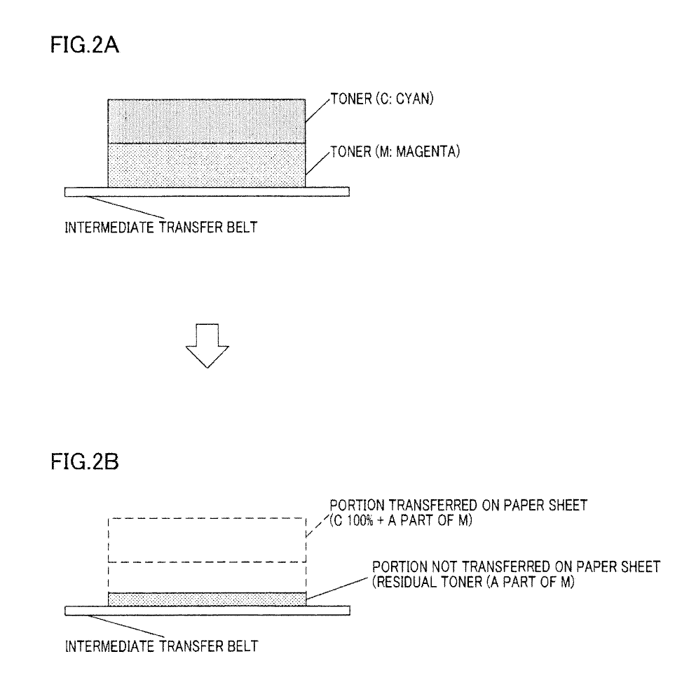

### DESCRIPTION OF EMBODIMENTS

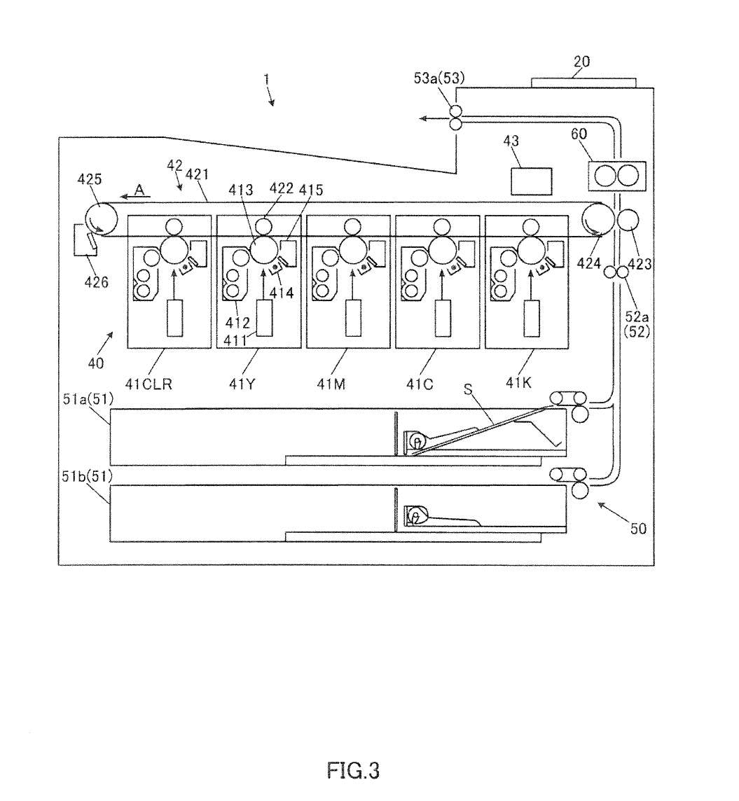

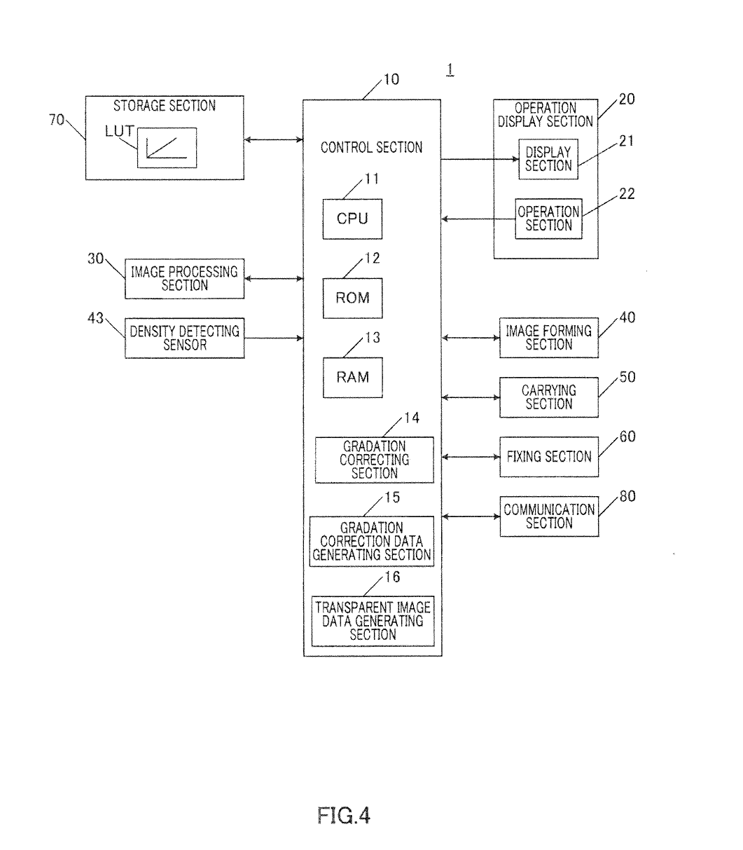

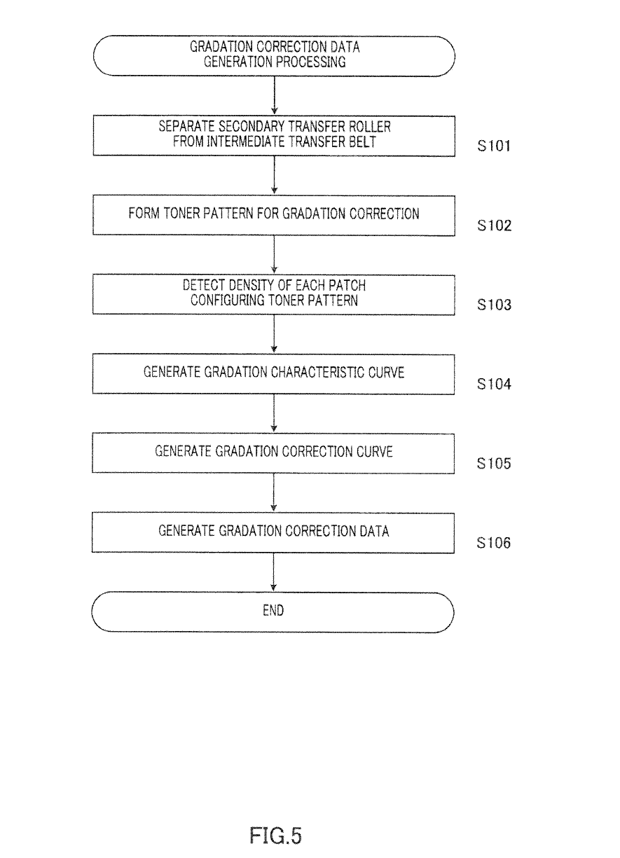

In the following, an embodiment according to the present invention will be described in detail with reference to the accompanying drawings. FIG. 3 schematically shows an entire configuration of image forming apparatus 1 according to an embodiment of the present invention. FIG. 4 shows a main part of a control system of image forming apparatus 1 according to the embodiment. Image forming apparatus 1 shown in FIG. 3 and FIG. 4 is an intermediate transfer-type color image forming apparatus (for example, a digital color printer) using the electrophotographic process. That is, in image forming apparatus 1, an image is formed in such a manner that color toner images of C (cyan), M (magenta), Y (yellow) and K (black) respectively formed on photoconductors are transferred (primary-transferred) on an intermediate transfer member so as to be superimposed on one another, and that the four-color toner image formed on the intermediate transfer member is then transferred (secondary-transferred) on a sheet. Further, in image forming apparatus 1, a tandem system is adopted in which the photoconductors corresponding to the four colors of CMYK are arranged in series in the running direction of the intermediate transfer member, and in which the respective color images are successively transferred on the intermediate transfer member by one procedure.

As shown in FIG. 3 and FIG. 4, image forming apparatus 1 includes control section 10, operation display section 20, image processing section 30, image forming section 40, carrying section 50, fixing section 60, storage section 70, and communication section 80.

Control section 10 includes CPU (Central Processing Unit) 11, ROM (Read Only Memory) 12, and RAM (Random Access Memory) 13, and the like. CPU 11 reads a program corresponding to a processing content from ROM 12 to decompress the program in RAM 13, and performs centralized control of each of the blocks of image forming apparatus 1 in cooperation with the decompressed program. At this time, various data stored in storage section 70 are referenced. Storage section 70 is configured, for example, by a nonvolatile semiconductor memory (so-called flash memory) or a hard disk drive.

Control section 10 transmits and receives various data via communication section 80 to and from an external apparatus (for example, a personal computer) connected to a communication network, such as a LAN (Local Area Network) and a WAN (Wide Area Network). Control section 10 receives, for example, image data transmitted from the external apparatus, and makes an image formed on a sheet on the basis of the image data (input image data). Communication section 80 is configured, for example, by a communication control card, such as, for example, a LAN card.

Further, control section 10 functions as gradation correcting section 14 which controls image processing section 30 to perform gradation correction based on gradation correction data, gradation correction data generating section 15 which generates gradation correction data used for the gradation correction, and transparent image data generating section 16 which generates transparent image data used to form a transparent toner image.

Operation display section 20 is configured, for example, by a liquid crystal display (LCD) provided with a touch panel, and functions as display section 21 and operation section 22. Display section 21 displays various operation screens, states of an image, operating states of respective functions, and the like, according to display control signals inputted from control section 10. Operation section 22 includes various operation keys, such as a numerical key and a start key, and outputs operation signals to control section 10 in response to various input operations by a user.

Image processing section 30 includes a circuit, and the like, which performs, to input image data, digital image processing according to an initial setting or a setting by the user. Image processing section 30 performs the gradation correction under the control of control section 10 on the basis of the gradation correction data (gradation correction table). Further, image processing section 30 performs, to the input image data, various correction processing, such as color correction, in addition to the gradation correction, and also performs compression processing, and the like. Image forming section 40 is controlled on the basis of the digital image data subjected to these kinds of processing.

Image forming section 40 includes image forming units 41Y, 41M, 41C and 41K for forming color images by toners of color components of Y, M, C and K on the basis of the input image data, image forming unit 41CLR for forming an image by a toner of a transparent component (transparent toner), intermediate transfer unit 42, density detecting sensor 43, and the like.

Image forming units 41Y, 41M, 41C and 41K for forming color images of the color components of Y, M, C and K, and image forming unit 41CLR for forming an image of the transparent component have the same configuration. For the sake of brevity of illustration and description herein, common components are denoted by the same reference numeral, and when the components need to be distinguished from each other, each of the components is denoted by attaching each of the characters of Y, M, C, K and CLR to the reference numeral. In FIG. 3, only the components of image forming unit 41 Y for component Y are denoted by reference numerals, and the reference numerals of the components of the other image forming units 41M, 41C, 41K and 41CLR are omitted.

Image forming unit 41 includes exposure device 411, developing device 412, photoconductor drum 413, charging device 414, cleaning device 415, and the like.

In image forming unit 41, charging device 414 electrifies photoconductor drum 413. Exposure device 411 is configured, for example, by a semiconductor laser, and irradiates the photoconductor drum 413 with laser light corresponding to each of the color components. Thereby, an electrostatic latent image of each of the color components (including the transparent component) is formed on the surface of photoconductor drum 413. Developing device 412 stores therein a developer (for example, a two-component developer containing small diameter-toner particles and magnetic carrier) of each of the color components and develops the electrostatic latent image (forms a toner image) by making the toner of each of the color components adhere to the surface of photoconductor drum 413. Further, cleaning device 415 removes a residual toner remaining on the surface of photoconductor drum 413 after primary transfer.

Image forming unit 41CLR for the transparent component is provided on the upstream side in the running direction of intermediate transfer belt 421 with respect to image forming units 41Y, 41M, 41C and 41K for the color components. That is, a transparent toner image, serving as an underlayer of each color toner image, can be formed on intermediate transfer belt 421 by image forming unit 41CLR for the transparent component. Image forming unit 41CLR forms a transparent toner image on the basis of transparent image data generated by transparent image data generating section 16 (control section 10).

Intermediate transfer unit 42 includes intermediate transfer belt 421 serving as the intermediate transfer member, primary transfer roller 422, secondary transfer roller 423, driving roller 424, driven roller 425, cleaning device 426, and the like.

Intermediate transfer belt 421 is formed as an endless belt, and is stretched between driving roller 424 and driven roller 425. Intermediate transfer belt 421 runs at a constant speed in the direction indicated by arrow A by the rotation of driving roller 424. When intermediate transfer belt 421 is brought into press contact with photoconductor drum 413 by primary transfer roller 422, respective color toner images are primary-transferred on intermediate transfer belt 421 so as to be successively superimposed on one another. Then, when intermediate transfer belt 421 is brought into press contact with sheet S by secondary transfer roller 423, the toner image primary-transferred on intermediate transfer belt 421 is secondary-transferred on sheet S. Further, cleaning device 426 removes a residual toner remaining on intermediate transfer belt 421 after the secondary transfer.

Density detecting sensor 43 is arranged to face intermediate transfer belt 421 on the downstream side in the running direction of intermediate transfer belt 421 with respect to the secondary transfer position at which the toner image is secondary-transferred on sheet S. For example, two density detecting sensors 43 are arranged to face both the width-direction side portions of intermediate transfer belt 421 (side portions in the direction perpendicular to the running direction of intermediate transfer belt 421). Density detecting sensor 43 is used when gradation correction data are generated, and detects the density of the toner pattern for gradation correction formed in the non-image forming area of intermediate transfer belt 421 (in both the width-direction side portions of intermediate transfer belt 421).

It is possible to apply, as density detecting sensor 43, a reflection type photosensor which includes, for example, a light emitting element, such as a light emitting diode (LED), and a light receiving element, such as a photodiode (PD), and which detects the reflection density of a toner pattern. When the amount of light incident on a measuring object is set as Iₒ, and the amount of light reflected from the measuring object is set as I, the reflection density of a toner pattern is expressed as −log (I/I₀). Further, when intermediate transfer belt 421 is made of a light-transmitting material, it is possible to apply, as density detecting sensor 43, a transmission-type photosensor in which a light emitting element and a light receiving element are arranged so as to face each other across intermediate transfer belt 421.

Fixing section 60 includes sections such as a pressing section which forms a nip section for holding and conveying sheet S, and a heating section which is brought into contact with sheet S with the toner image transferred thereto and heats sheet S at a fixed temperature. A known technique can be applied to fixing section 60. Fixing section 60 fixes a toner image on conveyed sheet S by press-heating sheet S in the nip section.

Carrying section 50 includes paper supply device 51, carrying mechanism 52, paper discharge device 53, and the like. Standard sheets and special sheets S identified on the basis of the basis weight, size, and the like, of the sheets are respectively stored in two paper feed tray units 51a and 51b which configure paper supply device 51.

Sheets S stored in paper feed tray units 51a and 51b are sent out one by one from the uppermost sheet, so as to be conveyed to image forming section 40 by carrying mechanism 52 provided with a plurality of feeding rollers, such as resist rollers 52a. At this time, the inclination of sheet S is corrected by the resist section in which resist rollers 52a are arranged, and also the conveying timing of sheet S is adjusted by the resist section. Then, the toner image formed on intermediate transfer belt 421 is collectively secondary-transferred on one surface of sheet S in image forming section 40, and fixing processing is applied to the transferred image in fixing section 60. Sheet S, on which the image is formed, is discharged to the outside by paper discharge device 53 provided with paper discharge roller 53a.

In this way, image forming apparatus 1 includes image forming unit 41 (image forming section) which, on the basis of the input image data, forms an electrostatic latent image on photoconductor drum 413 (photoconductor) by exposure device 411, and which forms a toner image by developing the electrostatic latent image by making a toner adhere to photoconductor drum 413 by developing device 412. Also, image forming apparatus 1 includes intermediate transfer unit 42 (intermediate transfer section) which transfers, on intermediate transfer belt 421 (intermediate transfer member), the toner image formed on photoconductor drum 413, and which transfers, on sheet S, the toner image transferred on intermediate transfer belt 421. Further, image forming apparatus 1 includes gradation correcting section 14 which performs gradation correction on the basis of the gradation correction data. Further, image forming unit 41 includes image forming units 41Y, 41M, 41C and 41K (first image forming sections) which respectively form color toner images on photoconductor drum 413, and image forming unit 41CLR (second image forming section) which is located on the upstream side with respect to the first image forming section and which forms a transparent toner image on photoconductor drum 413.

Here, the “upstream side of the first image forming section” means the side on which a toner image can be formed on the intermediate transfer member before the image formation by the first image forming section, and means the upstream side in the running direction of intermediate transfer belt 421 in the present embodiment.

FIG. 5 is a flow chart showing an example of gradation correction data generation processing. The gradation correction data generation processing shown in FIG. 5 is realized, for example, in such a manner that CPU 11 executes a predetermined program stored in ROM 12 according to the turning on of the power source of image forming apparatus 1. Further, it is desirable that, after gradation correction data are once generated, subsequent gradation correction data are generated by performing the gradation correction data generation processing periodically or at times such as when a predetermined time period elapses, when the formation of a predetermined number of images is completed, or when the toner of developing device 412 is exchanged.

In step S101 in FIG. 5, control section 10 makes secondary transfer roller 423 separated from intermediate transfer belt 421. This is performed in order that the toner pattern formed on intermediate transfer belt 421 is prevented from being transferred on secondary transfer roller 423.

In step S102, on the basis of image data for gradation correction, control section 10 makes each of image forming units 41Y, 41M, 41C and 41K form a toner pattern of each of the colors on intermediate transfer belt 421. The image data for gradation correction are stored, for example, in ROM 12.

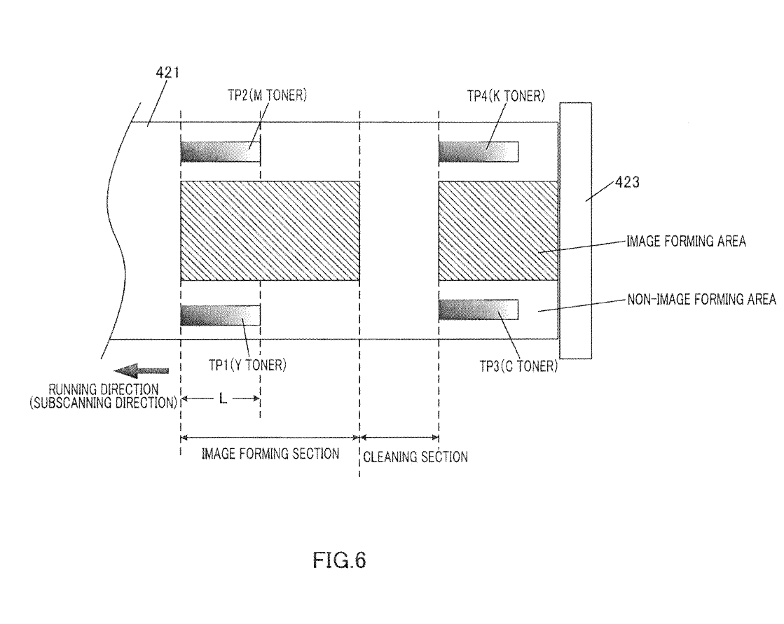

FIG. 6 shows an example of a toner pattern formed on intermediate transfer belt 421. In FIG. 6, the image forming area is an area in which a toner image can be formed by image forming unit 41, and the non-image forming area is an area in which no toner image is formed by image forming unit 41. As shown in FIG. 6, toner patterns TP1 to TP4 of respective colors of CMYK are formed in the non-image forming area of intermediate transfer belt 421, that is, in both width-direction side portions of intermediate transfer belt 421. Test patterns TP1 to TP4 are continuously arranged along the running direction of intermediate transfer belt 421, and are configured by a plurality of patches whose gradation values are changed stepwise (for example, configured by patches having gradation values of 0, 30, 60, 90, 120, 150, 180, 210 and 240 when the density variation is represented by 256 gradations). The width of each of the patches configuring the toner patterns TP1 to TP4 is set larger than the detection width of density detecting sensor 43 so that the density of each of the patches can be accurately detected by density detecting sensor 43.

In step S103 in FIG. 5, on the basis of the detection result obtained by density detecting sensor 43, control section 10 detects the reflection density of each of the patches configuring the toner patterns TP1 to TP4. The toner patterns formed on intermediate transfer belt 421 are removed by cleaning device 426 after passing through the detection area of density detecting sensor 43.

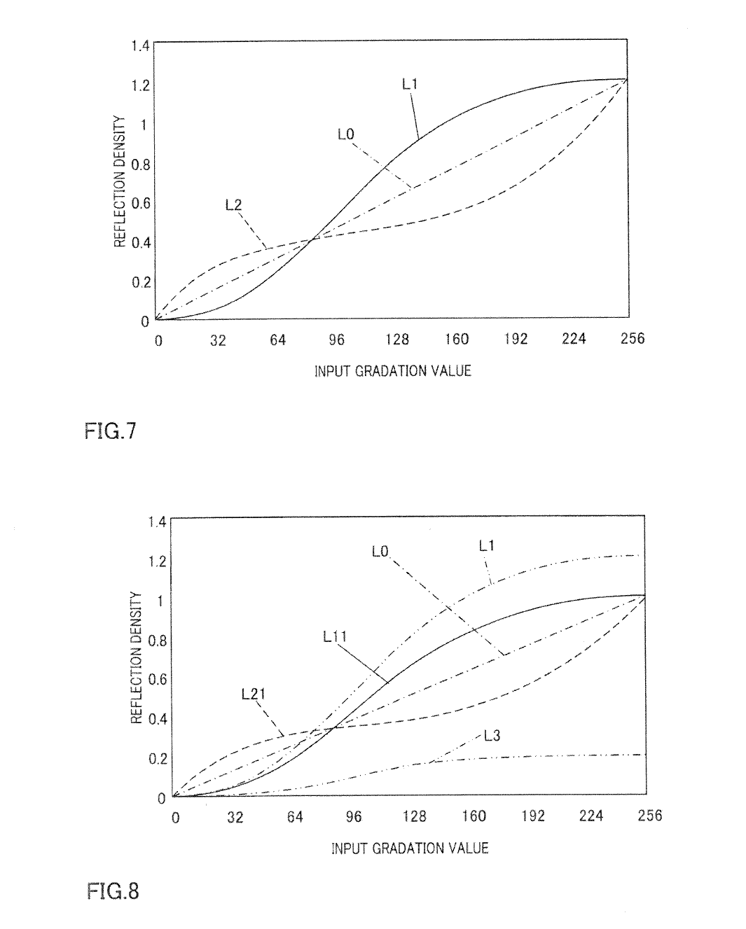

In step S104, control section 10 generates a gradation characteristic curve by associating the gradation values of the respective patches (input image gradation values (input gradation values) for forming respective patches), with the reflection density detected in step S103. The gradation characteristic curve is represented, for example, by curve L1 shown in FIG. 7. Note that the detected reflection density is normalized (normalized, for example, by 256 gradations), and the gradation characteristic curve can also be represented by output gradation values (output image gradation values) with respect to input gradation values. In the present embodiment, a transparent toner image is formed, as the underlayer of the color toner image, on intermediate transfer belt 421, and hence the transfer ratio of the color toner to sheet S becomes 100%. That is, the gradation characteristic curve L1 generated in step S104 becomes a gradation characteristic curve of the output image reproduced on sheet S.

In step S105, on the basis of gradation characteristic curve LI generated in step S104, control section 10 makes the gradations of the input image faithfully reproduced in the output image, that is, generates a gradation correction curve (gamma correction curve) L2 for correcting the gradation values of the input image so that target gradation characteristic L0 shown in FIG. 7 can be obtained. The gradation correction curve L2 is represented by a curve which is line symmetrical to gradation characteristic curve L1 with respect to target gradation characteristic L0. When the input gradation value is set as x, and also the output gradation value is set as y, and when gradation characteristic curve L1 is expressed as y=f(x), target gradation characteristic L0 is expressed as y=x, and hence gradation correction curve L2 is expressed as the inverse function (y=f⁻¹(x)) of gradation characteristic curve L1.

In step S106, on the basis of gradation correction curve L2 generated in step S105, control section 10 generates gradation correction data (gradation correction table) that associates the input gradation values with the correction gradation values to which the input gradation values are to be corrected. The generated gradation correction data are stored, for example, in RAM 13. When the output image is formed, gradation correction is performed by referring to the gradation correction data, and image forming conditions are determined on the basis of the correction gradation values.

Conventionally, the gradation correction data have been generated as follows at the time of secondary transfer in consideration of the toner left on intermediate transfer belt 421. FIG. 8 is a view showing a gradation correction curve conventionally adopted to generate the gradation correction data.

That is, toner patterns (regular toner patterns) are formed on intermediate transfer belt 421 similarly to the present embodiment, gradation characteristic curve L1 is generated on the basis of the density of the regular toner patterns. Gradation characteristic curve L1 includes the density with respect to the toner left on intermediate transfer belt 421 at the time of secondary transfer and hence is different from the gradation characteristics of the output image actually transferred on sheet S.

For this reason, in the state where secondary transfer roller 423 is brought into press contact with intermediate transfer belt 421, the regular toner patterns are intentionally transferred on secondary transfer roller 423. Then, gradation characteristic curve L3 of the residual toner pattern is generated on the basis of the density of the toner pattern (residual toner pattern) left on intermediate transfer belt 421 after the transfer.

Actual gradation characteristic curve L11 representing the gradation characteristics of the output image to be actually transferred on sheet S is generated by subtracting gradation characteristic curve L2 from gradation characteristic curve L1. Then, gradation correction curve L21, that is, gradation correction data are generated on the basis of actual gradation characteristic curve L11.

In this way, gradation correction data used for the gradation correction in the present embodiment can be more easily generated as compared with the conventionally used gradation correction data. Further, the gradation correction data in the present embodiment can be directly obtained from the detection result of the regular toner patterns (there is no need to consider the residual toner pattern), and hence have less error. Therefore, the accuracy of gradation correction is improved.

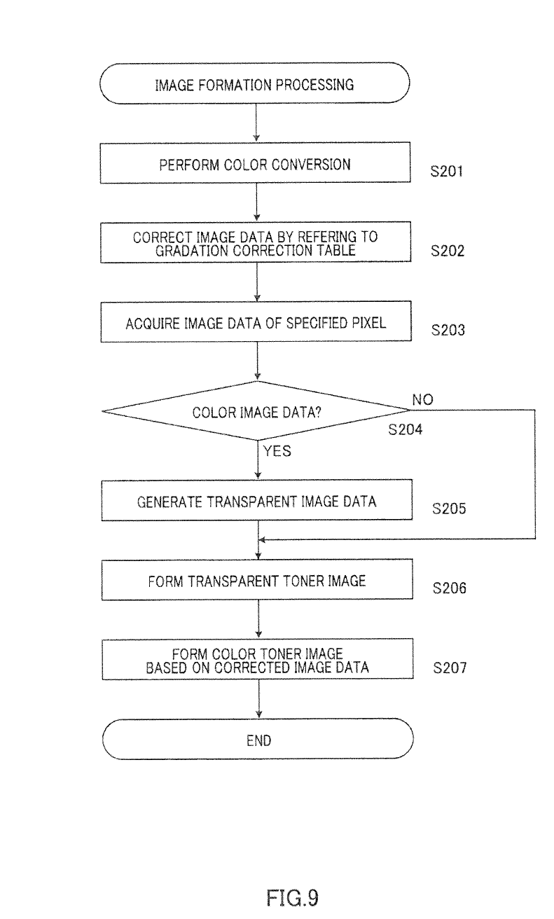

FIG. 9 is a flow chart showing an example of image forming processing in image forming section 40. The image forming processing shown in FIG. 9 is realized in such a manner that CPU 11 executes a predetermined program stored in ROM 12, for example, in response to a print instruction command transmitted together with input image data from an external apparatus to image forming apparatus 1.

In step S201 in FIG. 9, control section 10 performs color conversion processing of the input image data by controlling image processing section 30. Input image data (gradation values) respectively color-separated into values of C, M, Y and K are generated by this processing.

In step S202, control section 10 performs gradation correction by controlling image processing section 30. Specifically, control section 10 corrects an input gradation value of each pixel to a correction gradation value by referring to the gradation correction data generated by the gradation correction data generation processing shown in FIG. 5. Not only when the pixel has a primary color, but also when the pixel has a secondary color or a tertiary color, control section 10 refers to the same gradation correction data.

In step S203, control section 10 acquires an image data of a specified pixel. This is performed in order to determine whether a transparent toner image is formed for each pixel.

In step S204, control section 10 determines whether the specified pixel is a color pixel. Then, when determining that the specified pixel is a color pixel, control section 10 shifts to the processing in step S205. When determining that the specified pixel is not a color pixel, control section 10 shifts to the processing in step S206.

In step S205, control section 10 generates transparent image data for forming a transparent toner image on the pixel. At this time, the toner amount (corresponding to the gradation value) for forming the transparent toner image may be set so that the transfer ratio of color toner formed to be superimposed on the transparent toner becomes 100%. For example, when the transfer efficiency of transparent toner is substantially the same as the transfer efficiency of color toner, it is possible to refer to the amount of the color toner (residual color toner) which is left on intermediate transfer belt 421 in the case where the transparent toner image is not formed. When the amount of the transparent toner is set to be substantially the same as the amount of the residual color toner, it is considered that the transfer ratio of color toner becomes 100%. Further, the amount of the transparent toner may be suitably changed according to the kind of the sheet on which the image is formed, and according to the environment (temperature, humidity) in which the image formation is performed.

When the amount of the transparent toner is set to be substantially the same as the amount of the residual color toner, the running cost is reduced because the cost of the transparent toner is lower than the cost of the residual color toner, with the cost of the pigment contained in the residual color toner being deducted. Further, when the transfer efficiency of the transparent toner is higher than the transfer efficiency of the color toner, the amount of the transparent toner can be set to be less than the amount of the residual color toner, and hence the running cost is further reduced.

Control section 10 performs the processing of steps S203 to S205 to all the pixels configuring the input image and generates transparent image data corresponding to the input image data.

In step S206, on the basis of the transparent image data generated in step S206, control section 10 controls image forming unit 41CLR to form a transparent toner image on photoconductor drum 413CLR. The transparent toner image is formed only on color pixels among all the pixels configuring the input image. The transparent toner image formed on photoconductor drum 413CLR is primary-transferred on intermediate transfer belt 421.

In step S207, on the basis of the corrected image data (correction gradation values) subjected to the gradation correction in step S202, control section 10 sets image forming conditions in each of image forming units 41Y, 41M, 41C and 41K, to make color toner images respectively formed on photoconductor drums 413Y, 413M, 413C and 413K. The color toner images respectively formed on photoconductor drums 413Y, 413M, 413C and 413K are formed so as to be superimposed on one another on the transparent toner image formed on intermediate transfer belt 421. In the case of a pixel of a primary color, one color toner is deposited on the transparent toner at the toner amount corresponding to the gradation value of the color. On the other hand, in the case of a pixel of a secondary color or a tertiary color, a plurality of color toners are deposited on the transparent toner at the toner amounts respectively corresponding to the gradation values of the colors.

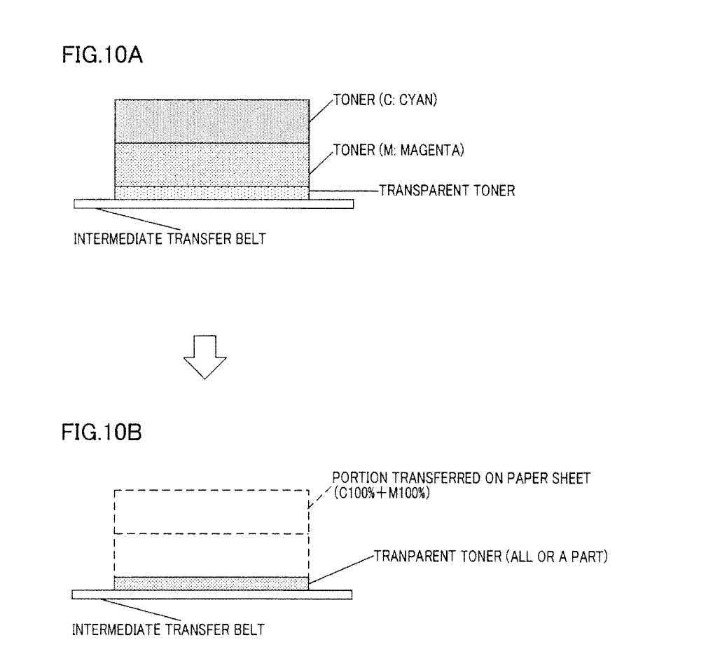

The toner images (color toner image/transparent toner image) formed on intermediate transfer belt 421 in this way is secondary-transferred on sheet S. At this time, all of the color toners are transferred at the transfer ratio of 100%. All or some of the transparent toner remains on intermediate transfer belt 421 (see FIG. 10). Therefore, a color toner image, having gradation values (densities) as designed, is formed on sheet S (the input image is faithfully reproduced). Note that, even when a part of the transparent toner is secondary-transferred on sheet S, the gradation characteristic of the output image is not affected at all.

As described above, in image forming apparatus 1 according to the present embodiment, image forming unit 41CLR (second image forming section) forms a transparent toner image on intermediate transfer belt 421 (intermediate transfer member) (in step S206 in FIG. 9), and then, on the basis of the image data subjected to the gradation correction (in step S202 in FIG. 9) by the gradation correcting section, image forming units 41Y, 41M, 41C and 41K (first image forming section) respectively form color toner images (in step S207 in FIG. 9) so that the color toner images are superimposed on one another on the transparent toner image.

With image forming apparatus 1, the color toner image is formed on the transparent toner image on intermediate transfer belt 421, and hence the color toner is completely transferred on the sheet at the time of secondary transfer, so that the transparent toner is left on intermediate transfer belt 421. Therefore, at the time of secondary transfer, it is not necessary to perform gradation correction in consideration of that the residual color toner is left on intermediate transfer belt 421, and hence an output image having desired gradation characteristics can be easily formed. Further, the color toner is not discarded as the residual toner, and hence the running cost can be reduced.

Further, image forming apparatus 1 includes density detecting sensor 43 (density detecting section) which detects the density of monochromatic toner patterns TP1 to TP4 that are respectively formed on intermediate transfer belt 421 (intermediate transfer member) by image forming units 41Y, 41M, 41C and 41K (first image forming section) on the basis of the image data for gradation correction. Also, image forming apparatus 1 includes gradation correction data generating section 15 (see the flow chart in FIG. 5) which generates gradation correction data on the basis of the result (gradation characteristic curve L1 in FIG. 7) obtained when the toner pattern (regular toner pattern) before being transferred on sheet S is detected by density detecting sensor 43. Further, the gradation correcting section (control section 10, image processing section 30) performs gradation correction on the basis of the gradation correction data generated by gradation correction data generating section 15.

That is, in image forming apparatus 1, the transfer ratio of the color toner becomes 100%, and hence the density of the toner pattern formed on intermediate transfer belt 421 can be regarded as the density on sheet S. Therefore, suitable gradation correction data can be easily generated as described above. Further, in the case where a multicolor image is formed, since the amount of each of the color toners becomes appropriate (the amount of each color toner other than the lowermost layer color toner does not become excessive as in the conventional image forming apparatus), an output image having desired gradation characteristics can be easily formed, and the running cost can be reduced.

Further, in image forming apparatus 1, image forming unit 41CLR (second image forming section) forms a transparent toner image (in steps S203 to S207 in FIG. 9) so that the transparent toner image coincides with each of the color toner images respectively formed by image forming units 41Y, 41M, 41C and 41K (first image forming sections). That is, the transparent toner image is formed only on color pixels. Thereby, the use amount of the transparent toner is suppressed as compared with the case where the transparent toner image is formed on each pixel, and hence the running cost can be further reduced. On the contrary, when the transparent toner image is formed on each pixel, uniform luster can also be given to the output image.

In the above, the invention made by the present inventors has been described specifically based on the embodiment, but the present invention is not limited to the above described embodiment, and various variations are possible within the scope and spirit of the invention. For example, as described in the embodiment, the present invention is particularly useful for a color image forming apparatus which forms a multicolor image by the superimposition of a plurality of color toners, but the present invention can also be applied to a monochromatic image forming apparatus which forms a monochromatic image.

Further, the present invention can also be applied to an image forming apparatus which forms a color toner image on one photoconductor drum and then correctively transfers the color toner image on a sheet, that is, an image forming apparatus in which the intermediate transfer member is formed by the photoconductor drum. Further, the present invention can be applied to any intermediate transfer-type image forming apparatus, and the configuration of the intermediate transfer section is not particularly limited.

The embodiment disclosed herein is to be regarded as illustrative in all respects, and not as restrictive. The scope of the present invention is indicated not by the above described explanation but by the appended claims, and is intended to include all changes and modifications within the meaning and range of equivalents of the appended claims.

### REFERENCE SIGNS LIST

1 Image forming apparatus

10 Control section

11 CPU

12 ROM

13 RAM

14 Gradation correcting section

15 Gradation correction data generating section

16 Transparent image data generating section

20 Operation display section

30 Image processing section

40 Image forming section

41 Image forming unit (image forming section)

41Y, 41M, 41C, 41K First image forming unit

41CLR Second image forming unit

411 Exposure device

412 Developing device

413 Photosensitive drum

414 Charging device

415 Cleaning device

42 Intermediate transfer unit

421 Intermediate transfer belt

422 Primary transfer roller

423 Secondary transfer roller

424 Driving roller

425 Driven roller

426 Cleaning device

43 Density detecting sensor (Density detecting section)

50 Carrying section

60 Fixing section

70 Storage section

80 Communication section

1. An intermediate transfer-type image forming apparatus comprising:
an image forming section including an exposure device for forming an electrostatic latent image on a photoconductor on the basis of input image data, and a developing device for developing the electrostatic latent image by making a toner adhere to the photoconductor to form a toner image;
an intermediate transfer section for transferring, on an intermediate transfer member, the toner image formed on the photoconductor and transferring, on a sheet, the toner image transferred on the intermediate transfer member; and
a gradation correcting section for performing gradation correction on the basis of gradation correction data,
wherein the image forming section includes a first image forming section for forming a color toner image on the photoconductor, and a second image forming section for forming a transparent toner image on the photoconductor, the second image forming section located on a upstream side of the first image forming section, and
wherein the second image forming section forms the transparent toner image on the intermediate transfer member and then the first image forming section forms, on the basis of image data subjected to the gradation correction by the gradation correcting section, the color toner image by superimposing the color toner image on the transparent toner image.

2. The image forming apparatus according to claim 1, further comprising:
a density detecting section for detecting a density of a monochromatic toner pattern, the monochromatic toner pattern formed on the intermediate transfer member by the first image forming section on the basis of image data for gradation correction; and
a gradation correction data generating section for generating gradation correction data on the basis of a detection result of the density of the toner pattern before being transferred on the sheet, the detection result obtained by the density detecting section,
wherein the gradation correcting section performs gradation correction on the basis of the gradation correction data generated by the gradation correction data generating section.

3. The image forming apparatus according to claim 2, wherein the second image forming section determines a toner amount used for forming the transparent toner image, according to a detection result of the density of the toner pattern transferred on the sheet, the detection result obtained by the density detecting section.

4. The image forming apparatus according to claim 1, wherein the second image forming section forms the transparent toner image so that the transparent toner image coincides with the color toner image to be formed by the first image forming section.

5. The image forming apparatus according to claim 1, further comprising one or more first image forming sections including the first image forming section, wherein all of the first image forming sections correspond to different colors.

6. An image forming method used in an intermediate transfer-type image forming apparatus for transferring, on an intermediate transfer member, a toner image formed on a photoconductor and transferring, on a sheet, the toner image transferred on the intermediate transfer member, the method comprising:
a first step of performing gradation correction on the basis of gradation correction data;
a second step of forming a transparent toner image on the intermediate transfer member; and
a third step of forming, on the basis of image data subjected to the gradation correction, a color toner image by superimposing the color toner image on the transparent toner image.

7. The image forming method according to claim 6, wherein the first step includes:
forming a monochromatic toner pattern on the intermediate transfer member on the basis of image data for gradation correction;
generating gradation correction data on the basis of a detection result of the density of the toner pattern before being transferred on the sheet; and
performing the gradation correction on the basis of the generated gradation correction data.

8. The image forming method according to claim 7, wherein, in the second step, a toner amount used for forming the transparent toner image is determined according to a detection result of the density of the toner pattern transferred on the sheet.

9. The image forming method according to claim 6, wherein, in the second step, the transparent toner image is formed so as to coincide with the color toner image that is formed in the third step.
